(19) United States
(12) Patent Application Publication
(10) Pub. No.: US 2009/0310185 A1
(43) Pub. Date: Dec. 17, 2009

(54) CREDENTIAL AND METHOD AND SYSTEM OF MAKING SAME

(75) Inventors: Jeffrey Phelan, Herndon, VA (US); Charles Adams, Silver Spring, MD (US); Doron Enav, Burke, VA (US); John Glover, Fairfax, VA (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: i6 LLC, Kearneysville, WV (US)

(21) Appl. No.: 12/519,976

(22) PCT Filed: Dec. 19, 2007
(86) PCT No.: PCT/US07/25933

§ 371 Date: Jun. 18, 2009

Related U.S. Application Data
(60) Provisional application No. 60/875,547, filed on Dec. 19, 2006.

(51) Int. Cl. H04N 1/40; H04L 9/32; G06F 21/00

(52) U.S. Cl. 358/3.28; 726/18

(57) ABSTRACT

A batch of credentials printed on a credential medium having a pattern of lenses (e.g., lenticular or other pattern), as well as a system and method for producing such credentials. A library of encoders is used to encode pixel locations of a plurality of view sets comprising a number of individual image frames. Each view set is associated with a distinct region on a credential having distinct polyoptic properties (e.g., orientation, frequency, shape). Encoded images produced by the library of encoders are combined (e.g., by interlacing or other encoding pattern) into a single print-ready image that is aligned (e.g., registered) with lenses of the distinct polyoptic areas on a medium on which the credential is printed. Encoding may take the form of positioning, sizing, intensifying, coloring, masking, interlacing, interleaving, scrambling, mixing, transformation, alteration, translation of pixels, or a combination thereof.

This application claims priority to provisional application No. 60/875,547, filed Dec. 19, 2006, which is incorporated by reference herein, in its entirety, for all purposes.

### BACKGROUND

1. Field of the Invention

The present invention relates to a credential and, more particularly, to a credential formed on a credential medium that includes a polyoptic region, as well as a system and method to produce such credentials.

2. Introduction

As access to more valuable assets, information, and facilities is granted to the bearer of a personal ID credential, the importance of validating the bearer and information carried as well as securing the physical carrier of this information is dramatically increased. There are two major security questions surrounding any given credential: 1) is this person the rightful bearer of this credential, and 2) is this credential authentic.

The generation of credentials that can meet security criteria such as those identified above is typically an intensive process. What is needed therefore is a credential production system and method that would enable the efficient creation of secure credentials that incorporate data that is unique to the credential or the person bearing the credential.

### SUMMARY

According to first aspect of the invention, there is provided a method of producing a credential for printing on a credential medium that includes at least one polyoptic region including a plurality of lens elements to enable viewing of respective images of a view set according to view angle. The method comprises retrieving a view set that includes at least two images; generating an encoding pattern that defines pixel characteristics of respective images of the view set; assigning pixel locations of the respective images on the credential medium according to an encoding pattern and the lens elements thereby to form an encoded image; and printing the encoded image on the medium according to assigned pixel locations thereby to enable viewing of respective images of the view set according to view angle. The credential medium may comprise a lens layer and/or one or more coating materials that carry a printed image or text. The print layer may be printed directly on the lens layer (e.g., a planar side of a polyoptic lens screen). The credential medium may also comprise print on a separate medium that is then combined with a lens layer to form a composite structure. The method may include a second or further polyoptic region and the method may further include retrieving a second view set that includes at least two images; generating a second encoding pattern that defines pixel characteristics of respective images of the second view set; assigning pixel locations of respective images of the second view set on the medium according to said second encoding pattern and the lens elements thereby to form a second encoded image; and printing the second encoded image on the medium according to assigned pixel locations to enable viewing of respective images of said second view set according to view angle.

Pixel characteristics of the encoding pattern may be defined by position, size, intensity, color, masking, interlacing, interleaving, scrambling, mixing, transformation, alteration, translation of said pixels, or a combination thereof. The images may be based on biometric information or biographic text information. The polyoptic region may include a plurality of lenses that produce one of an appear/disappear, color switch, color wash, image switch, movement, moving pattern, parallax, and size change effect in response to a change in view

In another aspect of the invention, there is provided a method of printing a credential on a medium that includes a polyoptic region defined by a plurality of lenses that enable viewing of respective images of a view set according to view angle. This method comprises obtaining an encoded image that embodies a view set that includes at least two images; assigning respective locations of pixels of said encoded image on the medium according to a pattern of said plurality of lenses on the medium and a desired view angle of each image of said view set; and printing said encoded image on the medium according to assigned pixel positions to enable viewing of respective images of said view set according to view angle.

Another aspect of the invention comprises a method of producing a credential image for printing on a credential medium having a polyoptic region defined by a plurality of lenses that enable viewing of respective images of a view set according to view angle where the method comprises encoding pixel characteristics of a plurality of images of the view set to form an encoded image; assembling the encoded image with a non-encoded image into a credential image; and printing the credential image onto the medium, wherein the encoded image is printed onto the polyoptic region of the medium and the non-encoded image is printed onto a non-polyoptic region of the medium.

Another aspect of the invention comprises a method of producing a group of encoded credential images for printing on a credential medium having at least one polyoptic region where the method comprises retrieving a dynamic image layer that includes an encoded image formed of a plurality of images having encoded pixels wherein at least one of said plurality of images is unique to a first credential; retrieving a static background layer that is not unique to the first credential; assembling the dynamic image layer and the static background layer into a first credential image; repeating the retrieving step to assemble a second credential image; and printing the first credential image and a second credential image together onto a unitary medium wherein the dynamic layers are printed in respective polyoptic regions of the medium and the static background layers are printed in non-polyoptic regions. The unitary medium may comprise a single lens layer sheet having a print enhancement coating (e.g., Topaz) printed on one side thereof and one or more further layers of printing or other coatings, or a composite structure that comprises multiple layers of printing, coating or material on one or more separate components along with a lens layer.

Another aspect of the invention comprises a system to generate an encoded credential image for printing on a credential medium. Such a system comprises an encoder that encodes a characteristic of pixels of a plurality of images of a view set to form an encoded image to permit viewing of respective images of said view set according to view angle where the encoded image has a printing size that is less than an area defined for a printed credential; an assembler that combines the encoded image with a non-encoded image into a credential image, and a printer to print the assembled image on the medium.

A further aspect of the invention comprises a batch of credentials produced during a production run that includes a credential medium on which each credential is placed. The medium includes a print medium and a polyoptic lens layer having a pattern of lens elements; and at least two credentials of the batch includes unique encoded images embodying pixels of at least two images having pixels encoded on the medium relative to the lens elements to enable, for each credential, a separate viewing of a distinct image according to a view angle. The pattern of lens elements may be rows of generally convex lenses. In addition, the pitch or frequency of the rows may vary within a polyoptic region.

A further aspect of the invention comprises a batch of credentials printed on a credential medium that includes at least one polyoptic lens layer having a plurality of lenses to enable viewing of respective images of a view set according to a view angle where the batch of credentials is produced by retrieving a view set that includes at least two images; providing an encoding scheme that defines a characteristic of pixels of respective images of said view set; assigning the characteristic to pixels of respective images thereby to form an encoded image; and printing the encoded image on the polyoptic lens layer of the medium according to the characteristic thereby to produce the batch of credentials each enabling viewing of respective images of their own view set according to a view angle.

A yet further aspect of the invention comprises a group of credentials printed on a credential medium that includes at least one polyoptic lens layer having a plurality of lenses to enable viewing of respective images of a view set according to a view angle. Such a group of credentials may be produced by obtaining an encoded image that embodies a view set of at least two images; assigning respective locations of pixels of the encoded image on the medium according to a pattern of the plurality of lenses and a view angle of each image of the view set; and for each credential of the group, printing the encoded image on the medium according to assigned pixel positions.

Another aspect of the invention comprises a set of credentials each being printed on a credential medium that includes at least one polyoptic lens layer having a plurality of lenses to enable viewing of respective images of a view set according to a view angle where the set of credentials is produced by, for at least two credentials of the set, encoding pixels of a plurality of images of a view set to form an encoded image; assembling the encoded image with a non-encoded image into a credential image; and printing the credential image onto the medium wherein the encoded image is printed onto a polyoptic area of the medium and the non-encoded image is printed onto a non-polyoptic area of the medium.

In yet another aspect of the invention, there is provided a plurality of credentials each being printed on a credential medium that includes at least one polyoptic lens layer having a plurality of lenses to enable viewing of respective images of a view set according to a view angle where each credential is produced by retrieving a dynamic image layer that includes an encoded image formed of a plurality of images having an encoded pixel characteristic wherein at least one of the plurality of images is unique to a first credential; retrieving a static background layer that is not unique to the first credential; assembling the dynamic image layer and the static background layer into a first credential image; and printing the first credential image and a second credential image together onto a single medium wherein said dynamic layers are printed in respective polyoptic areas of the medium.

A credential medium is disclosed as well as a system and method to generate an image for printing onto a medium, substantially as shown in and/or described in connection with at least one of the figures, and as set forth in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of a credential production process.

FIG. 2 illustrates an example of a credential medium and various image frames viewable upon a change of view angle.

FIG. 3 illustrates a flowchart of a process of generating credential image components based on credential data in a remotely or locally accessed database.

FIG. 4 illustrates an example of data elements that may be incorporated into a credential.

FIG. 5 illustrates an example of a credential that uses a credential medium comprising a number of polyoptic or lens regions overlying a sheet medium.

FIG. 6 illustrates an example of layers incorporated into a finished credential formed on a portion of print grid.

FIG. 7 illustrates an example of interlaced image frames viewable in accordance with placement of pixel elements of respective image frames on a medium.

FIG. 8 illustrates an example of view sets (e.g., sets of image frames) viewable on respective regions of a credential medium in accordance with a change in view angle or viewing position.

FIG. 9 illustrates an example of encoding or pixel interlacing to create an underlying combined or interlaced image embodying respective image frames the become separately viewable in response to a change in viewing angle or position.

FIG. 10 illustrates an example of assembling multiple polyoptic regions to produce a credential.

FIG. 11 illustrates an example of tiling multiple credentials on a sheet medium.

FIG. 12 shows a variable lens pitch or frequency, which may be formed in polyoptic regions.

FIG. 13 shows different shaped lenses in a variable lens configuration that may be incorporated in a polyoptic region of an encoded credential.

FIG. 14 shows an arrangement of horizontal and vertical rows of lens that may be incorporated in a polyoptic region.

FIG. 15 shows a variable pitch lens that may be incorporated into a lens arrangement similar to that shown in FIG. 14.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

The teachings of the present invention enable the creation of a tamper-proof, tamper-evident, anti-counterfeiting credential management system and method. In general, a credential can represent any printed item utilized to identify and/or authenticate an individual, item, or representation of an individual or item. Examples of a credential include identity cards, citizen cards, driver's licenses, passports, work permits, breeder documents (e.g., social security card, birth certificates), social/medical benefits cards (e.g., health, dental, prescription, vision, unemployment, etc), tickets, labels, seals, tags, packaging, certificates of authenticity, container seals, etc. As such, the principles of the present invention can be applied in various industries or markets such as advertising, promotions, software, pharmaceuticals, tobacco, spirits, replacement parts, luxury goods, banknotes, IDs, packaged entertainment, ticketing, etc.

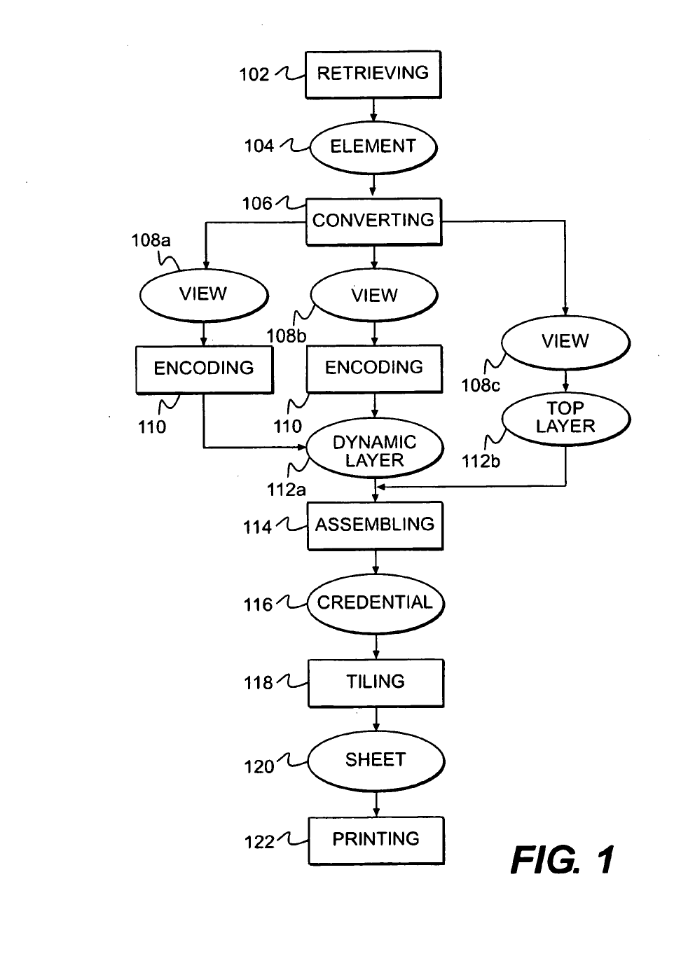

FIG. 1 illustrates an embodiment of a credential production process. To facilitate the construction of credentials, the credential production process can be described as a system that mimics an assembly line, wherein raw biometric and biographic data of an individual is used to create a finished credential.

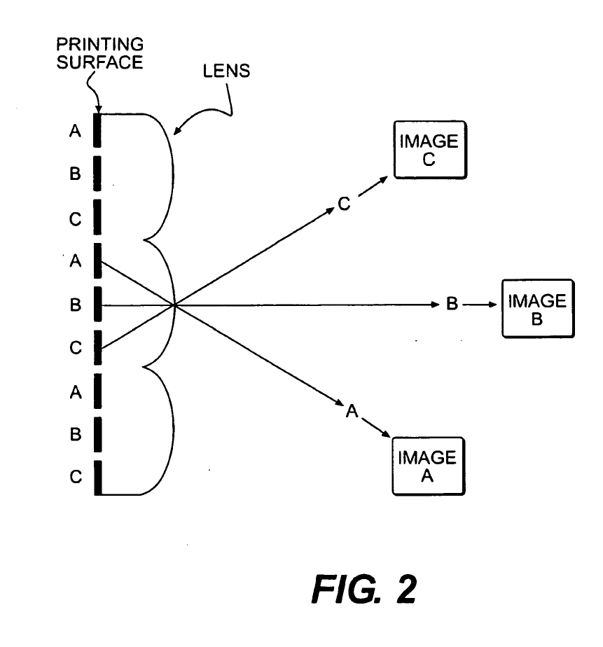

The credentials produced by the credential production process are created using polyoptically-encoded images. In general, a polyoptically-encoded image is formed using a printed image and a polyoptic lens layer through which the printed image is viewed. FIG. 2 illustrates an example of a credential medium comprising a lens layer and print layer. In one embodiment, the credential medium includes a polyoptic lens layer in the form of a sheet of plastic screen on which a series of convex or parabolic lenses are molded in parallel rib-like rows. A print enhancement coating to enable adherence of printing ink, such as a coating commercially known as Topaz, is placed on a back side of the polyoptic lens layer and an image is printed onto the coating, or directly onto the lens layer. In this case, each of the individual polyoptic lenses magnifies a small portion (e.g., a few pixels wide) of the image that is printed on the coating underlying the polyoptic lens layer. Instead of rib-like rows, the lenses may be molded in other patterns. Alternatively, instead of a coating, the lens layer and a separate print medium may also be laminated or otherwise combined together or combined with other layers to form a polyoptic print medium. As illustrated, three strips taken from respective images A, B, and C are printed behind respective rows of the polyoptic lens layer. In this arrangement, as the viewer changes the angle of view, the strip that is being magnified by the polyoptic lens layer also changes. The resulting change between images A, B, and C in association with the change in angle of view produces an animation effect between images A, B, and C. Although only three image strips are shown, the number of image strips and rows of the polyoptic print medium may vary from a lower or higher number, e.g., ten or more—being limited only by the printing and registration accuracy.

As illustrated, the credentials move through six different stages of processing, starting with raw data and ending with a finished physical credential. The stages are illustrated as follows: retrieval stage 102, which includes data element 104 retrieval from the database; converting stage 106, which includes conversion of the raw data into graphical elements; encoding stage 110, which includes encoding of the graphical elements for viewing through the polyoptic lens layer; a RIP'ing stage 114 which includes converting the image to a print-ready format; tiling stage 118, which includes consolidation of multiple credentials onto a single sheet 120 for printing, and printing stage 122, which includes physical printing of the credentials and/or assembly of the separate layers, if appropriate.

These six stages are processed, in order, for each credential. In various scenarios, there may be dependencies between the different stages depending on the complexity of the credential, such as data characteristics, polyoptically based effects, printing hardware, etc. In certain cases, the order of processing may vary and certain steps may be omitted. Additional steps may also be incorporated.

As illustrated, stages produce artifacts that are described herein as products. These products represent partially finished components of the final credential. For example, the first product is produced by retrieval stage 102, which product is consumed by converting stage 106. Each stage may produce more than one of these products. In the embodiment of FIG. 1, the five illustrated products include the following: element product 104, which includes the raw data (biometric, biographic, or any unique identifying information such as a bar code, serial number, product tag, etc.) of the credential; view product 108a, 108b, etc., which includes a subset of a polyoptic view of the credential, layer product 112a, 112b, etc., which includes a single image layer of the credential, credential product 116, which includes a print-ready representation of the credential, and sheet product 120, which includes a print-ready layout of a plurality of credentials. The final result of the process is the finished, printed credential, which is produced by printing stage 122.

Retrieval stage 102 is the first stage and includes basic setup and packaging of data. The input to retrieval stage 102 is the credential's ID that is used to universally describe a single credential throughout its entire lifetime.

A primary purpose of retrieval stage 102 is to take a credential ID and retrieve all relevant data. In one embodiment, retrieval stage 102 would retrieve biographic text data, biometric graphic data, and template data that will be used in constructing the credential. In one embodiment, the template data defines what data is to be included in the credential, where data is to be placed (layout), and any dynamic data relationships. This retrieved data is packed into an element product, which would then be consumed or used by the subsequent converting stage 108.

As noted, retrieval stage 102 can be designed to retrieve personal information such as biometric text data (e.g., name, address, security level, seat number, etc.) and biometric graphic data (e.g., picture, fingerprint, or any other unique identifying formation such as a bar code, SKU number, etc.). In one embodiment, retrieval stage 102 can also be designed to determine and retrieve personalized data relationships. In general, the appearance of any element or set of elements may be modified based on information derived through dynamic data relationships defined in a credential template. For example, a dynamic data relationship can be defined that would optically generate a certain advertisement on an admission ticket based on a row number for the ticket. As would be appreciated, the dynamic data relationship can be driven by any piece of data that is associated with a given credential.

In one embodiment, defining a template involves two separate processes: 1) identifying the personal data elements and specifying where on a credential medium these elements are to be placed, and 2) specifying any relationship(s) between personalized elements such that a specific value of element one determines the value of element two. For example, an employee type element (contractor, full-time, part-time) could determine the color of the frame around the employee's portrait when placed on the medium.

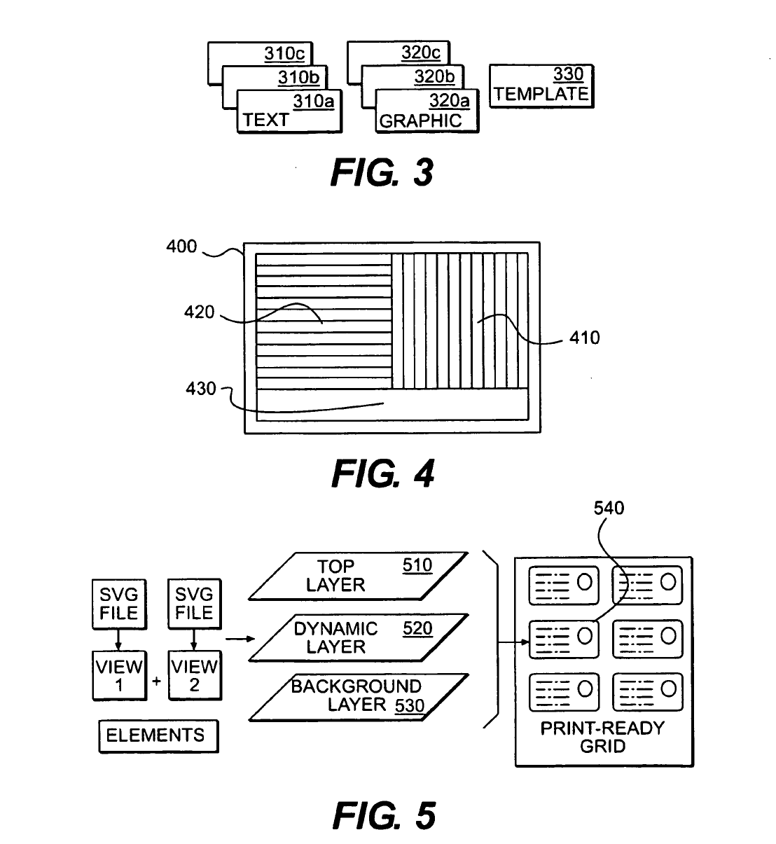

FIGS. 3 and 4 illustrate an example of a positional relation between retrieved data and a credential printed or placed on a credential medium 400. In this example, three types of data are retrieved by retrieval stage 102 (FIG. 1). This may include biometric text data 310a, 310b, 310c, biometric graphic data 320a, 320b, 320c, and template data 330. Polyoptic medium 400 has a variable lens layer structure that provides a plurality of regions 410, 420, 430. Each region generates a different visual effect when visually examined by a user. In the illustrate example, region 410 has lenses arranged in vertical rows, thereby providing a first animated effect when the angle of view is swept horizontally. Region 420, on the other hand, has lenses arranged in horizontal rows, thereby producing a second animated effect when the angle of view is swept vertically. Finally, region 430 is designed to produce no animated visual effect when changing the angle of view. It should be noted that in this example, different regions of the polyoptic medium 400 are produced using different orientations of lenses. In other embodiments, different regions of a polyoptic medium can be produced by sets of lenses having different planar configurations, lens shapes or properties, focal points, frequencies or row periodicity, and/or orientations. Thus, a variety of visual effects of a credential may be generated upon changing the angle of view of the medium.

In the example of FIG. 4, biometric text data 310a, 310b, 310c are mapped to region 410, biometric graphic data 320a, 320b, 320c are mapped to region 420, and data identified by template 330 is mapped to region 430. In this arrangement, the credential produced by polyoptic medium 400 would produce a first animation in region 410 when the credential is moved in relation to the eye horizontally and a second animation in region 420 when the credential is moved in relation to the eye vertically. In general, one or more effects can be obtained by moving the credential or angle of view in any direction relative to the eye, which change would create a view of different image data printed behind respective lenses of the polyoptic medium.

Converting stage 106 (FIG. 1) operates on or transforms element product 104 obtained by retrieval stage 102. Here, all of the text data in element product 104 is extracted and rendered as graphical elements and all of the graphic data (including any rendered text) are scaled and processed to match the template's specifications.

FIG. 5 illustrates an embodiment of a conversion process based on a template defining a plurality of layers. In the example of FIG. 5, the template defines three layers: top layer 510, dynamic layer 520, and background layer 530. Both top layer 510 and background layer 530 may comprise static images that are defined components of the design template. Dynamic layer 520, on the other hand, incorporates dynamic data elements such as personal information and personalized data of an individual. As illustrated in FIG. 5, dynamic layer 520 is designed to incorporate two views (i.e., source images) that are auto-generated from SVG templates and personalized data elements that are generated based on pre-defined dynamic data relationships.

The three layers 510, 520, and 530 are combined into a single composite image for a single credential 540 in a print-ready grid. Here, it should be noted that each credential in the print-ready grid would have data that is generated by its own respective dynamic layer. Accordingly, each credential in the print-ready grid would be distinct since it is based on a unique set of data.

The print-ready grid that is ultimately generated is designed to be applied to a polyoptic medium that defines a plurality of regions for each credential. Each of the plurality of regions for a credential can produce a different polyoptic effect for the underlying set of source images. Each individual source image is called a view, and a set of source images is called a view set. As the credential is moved relative to the eye, a different view in a view set will be visible. In this way, a view is similar to a single frame of an animation. Rather than the views changing over time, the views change depending on the orientation of the credential. The views are grouped together in a view set based on the template specifications.

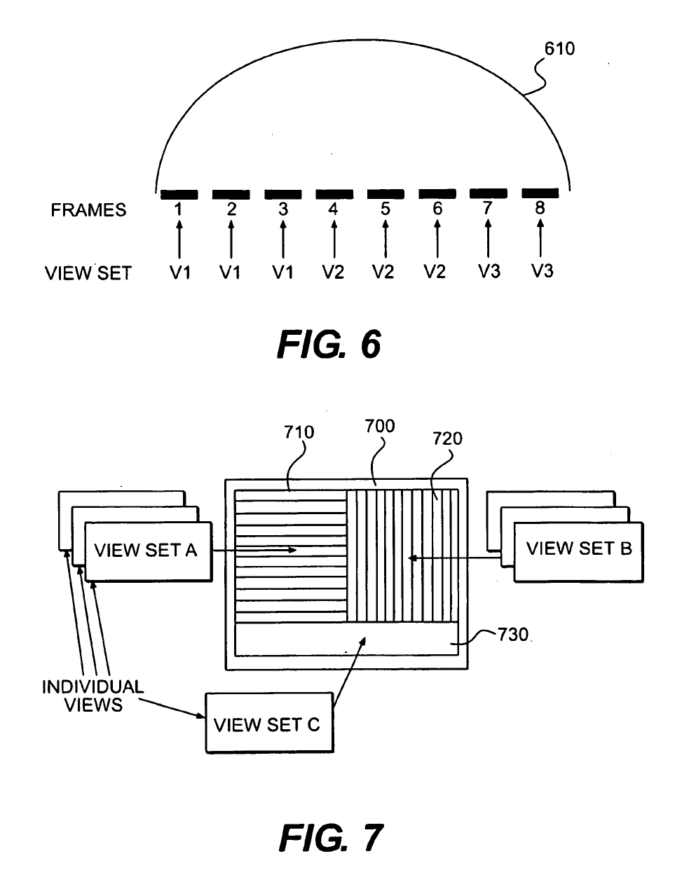

FIG. 6 illustrates the relation between frames and a view set. As illustrated, printed behind a lens element 610 of the medium is a set of addressable frames 1-8 that are visible behind lens 610 depending on the view angle. In one example, these eight addressable frames would result when an 800 dpi printer is used with a polyoptic area having a periodicity, pitch or frequency of 100 lenses/inch (lpi).

Each view in a view set is assigned to one or more frames. In the example of FIG. 6, views V1, V2, and V3 are assigned to frames 1-8. As illustrated, view V1 is assigned to frames 1-3, view V2 is assigned to frames 4-6, and view V3 is assigned to frames 7-8. In this assignment, the animation of views V1, V2, V3 in the view set would be seen as lens 610 sequentially brings the data in frames 1-8 into view.

For example, if an effect is desired wherein all the text images are to move from red to blue to green, then the following three template files are defined: one that specifies the text elements as red, one that specifies the text elements as blue, and one that specifies the text elements as green. Here, each SVG element defines a view of the data that will be encoded with all the other views to create the dynamic layer of the credential.

Each of these views is then assigned to some set of underlying frames. If eight frames exist and a smooth color change is desired, then the first view can be assigned to frames 1-3, the second view assigned to frames 4-6, and the third view assigned to frames 7-8. This view to frame assignment can be handled by mask parameters defined in the template. For example, each view element can have a plurality of values that specifies the view number and the number of frames on which that view will appear. In the above example the polyoptic mask would look as follows: View(1,3); View(2,3); View(3,2). Here, there are three views. View 1 is placed on the first three frames, view 2 is placed on the next three frames and view 3 is placed on the last 2 frames. The result of looking at this encoded image would then be a transition of the font color from red to blue to green as the credential was moved relative to the eye.

FIG. 7 illustrates the relation between view sets and regions on a polyoptic medium. As illustrated, polyoptic medium 700 includes regions 710, 720, and 730. Region 710 defines a field providing a vertical polyoptic effect and has view set A assigned to it. View set A consists of three individual views. Region 720, on the other hand, defines a field providing horizontal polyoptic effect and has view set B assigned to it. View Set B also consists of three individual views. Lastly, Region 730 defines a no effect region and has view set C assigned to it. View set C consists of a single view.

As illustrated, each of view sets A, B, and C span single regions on the polyoptic medium. It should be noted, however, that it is possible for a single graphic (or text) to span more than one region on the medium. In this case, the source images may be altered, cropped, or combined to create the appropriate views for a particular region.

In encoding stage 110 (FIG. 1), views created by converting stage 106 are encoded to create a single image. An encoded image is designed to be viewed under a polyoptic lens layer and is specially formatted to display a single view depending on the angle of view of the image. As noted above, the encoded image produced by encoding stage 110 is a layer, such as dynamic layer 112a.

Different types of polyoptic material can create different effects. It therefore follows that for each polyoptic effect a different encoding process can be used to encode the views. In one embodiment, there is a library of encoders, each one containing a distinct encoding process. By way of example, polyoptic materials include plastics commercial known as PET, PETG, PVC, PBT, Lenstar, etc.

Each view set for a particular region on the polyoptic medium is encoded by a single encoder to create a single layer. Since there can be multiple effect types per credential, there can be multiple encoders in use at a single time, each one processing a different view set and creating a different layer. For example, visual or polyoptic effects such as appear/disappear, color switch, color wash, image switch, animation, movement, moving pattern, parallax, size change, etc. can be implemented. A combination of these effects may also be implemented. In any given field or region on the medium, the lens pitch or frequency may also vary to provide additional effects from, for example, from one hundred to three hundred lenses per inch, more or less with a corresponding variation in printing density (e.g., dpi) or resolution to accommodate frame assignments.

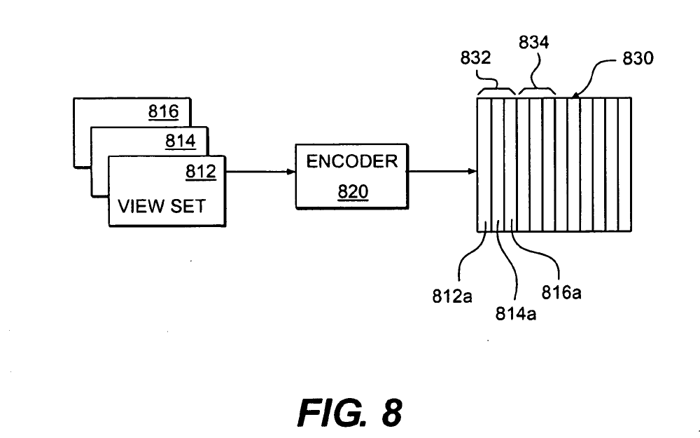

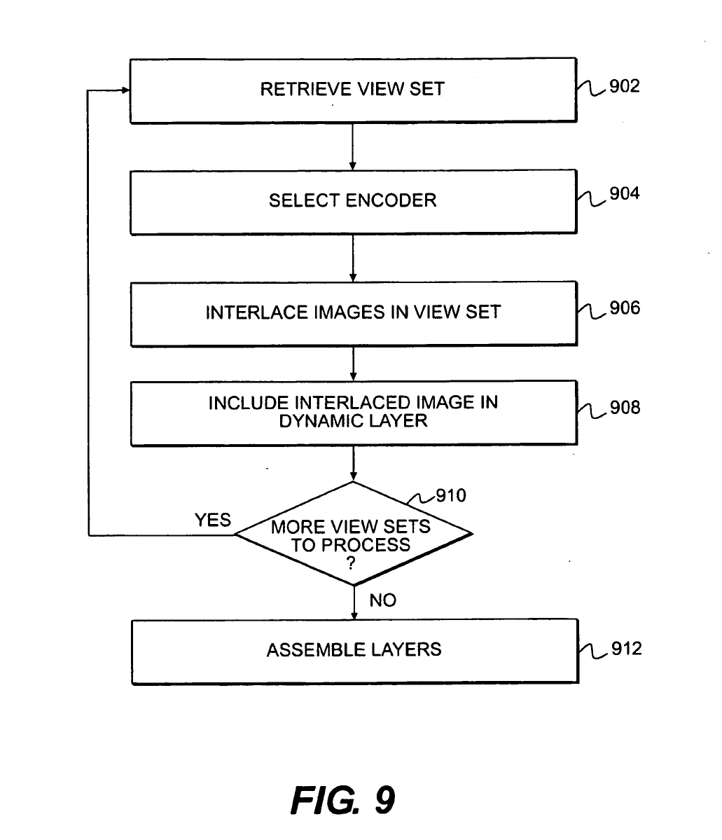

FIG. 8 illustrates an example illustration of encoding stage 110, which process will be described with reference to the flowchart of FIG. 9. As illustrated in the flowchart of FIG. 9, the encoding process begins at step 902 where a view set is retrieved. This view set is illustrated in the example of FIG. 8 as containing views (or images) 812, 814, 816. Each of views 812, 814, 816 represents a distinct image that will be in view when the credential is held at a certain viewing angle. When viewed sequentially, views 812, 814, 816 would then provide a certain polyoptic effect.

For example, views 812, 814, and 816 can contain an object at three different positions, wherein the sequential viewing of those three object positions would produce an animation effect. In another example, views 812, 814, and 816 can contain three different images (e.g., picture, fingerprint, and company logo) that would alternatively appear in a single region on the credential depending on the angle of view. As would be appreciated, the content and relation between the various views would be dependent on the type of polyoptic effect desired in that region of the credential.

In the example of FIG. 8, the encoding process is designed to generate a print-ready image that can be applied to a region of polyoptic medium that has vertically-aligned lenses designed to produce a horizontal polyoptic effect. The generation of the print-ready image that can be applied to that region of polyoptic medium is the responsibility of encoder 820. As would be appreciated, encoder 820 is specifically designed to produce a print-ready image for a defined polyoptic region.

It is a feature of the present invention that a single credential can have multiple regions with distinct polyoptic properties. For example, a single credential can have a first region with vertically-aligned lenses designed to produce a horizontal polyoptic effect, and a second region with horizontally-aligned lenses designed to produce a vertical polyoptic effect. This example illustrates regions that have a different orientation property. In another example, a first region can have 100 lenses/inch, while a second region can have 50 lenses/inch. This example illustrates regions that have a different lens frequency property. In general, the various distinct polyoptic regions defined for a credential can differ in one or more of the size, occurrence, direction, orientation, frequency, or lens shape properties.

To generate a print-ready image for a distinct region having defined polyoptic properties, a specific encoder is used. The specific encoder for the distinct region is selected at step 904. This selected encoder is designed to generate an image (from the retrieved view set) that corresponds to the individual lens areas within the distinct region. As multiple regions with distinct polyoptic properties can be defined for a single credential, multiple encoders, or multiple configurations of an encoder, can be used.

After the particular encoder is selected, the view images in the retrieved view set are encoded at step 906 into, for example, an assigned frame. In one embodiment, a bitmask encoder is used that is designed to encode a series of input images together to form a final, polyoptic-oriented image using pre-determined, and cached, bitmasks (or polyoptic screen filters). For each input image, a bitmask is created that represents which pixels should, or should not be included in the final encoded image. Which pixels are filtered out is governed by the desired polyoptic medium configuration. This configuration could relate to different lens sizes, occurrences, directions, orientations, frequencies, or shapes. In one embodiment, these bitmasks are represented as a series of high (white) and low (black) pixels that mean include-this-pixel and do-not-include-this-pixel, respectively. After creation, the bitmasks are cached in memory where they can be used again and again.

During processing, each input image has its corresponding bitmask applied to it using a bitwise AND operation (e.g., any pixel which is non-black in both the input image and the bitmask is kept). Once each of the input images has been filtered, they are combined into a final, encoded image using a bitwise OR operation (e.g., keep any pixel which is non-black in any of the images).

In the example of FIG. 8, encoder 820 encodes bitmask segments 812a, 814a, and 816a (taken from views 812, 814, and 816, respectively) into an area 832 of layer 830. Area 832 is the area defined for a single lens in a polyoptic region. As illustrated, a second set of bitmask segments (also taken from views 812, 814, and 816, respectively) would be encoded into the next lens-defined area 834 of layer 830. This process would be repeated to cover the entire layer 830.

At step 908, the resulting encoded image is included in the dynamic layer. At step 910, it is then determined whether there are any additional view sets to be processed. As noted, these additional view sets can be assigned to other regions of the credential that have different polyoptic properties. If there are additional view sets to be processed, then the process would return to step 902, where the additional view set is retrieved for processing. Here, it should be noted that while the example flowchart of FIG. 9 illustrates sequential processing of view sets, actual implementations can choose to process the view sets in parallel. Once a credential is complete it may then be converted to a print ready format through the RIPing stage.

If, at step 910, it is determined that there are no more view sets to process, then the process continues at step 912, where the various layers (e.g., top, dynamic, background) are assembled. In general, the layers that were generated by encoding stage 110 are each pieces of the final credential, much like pieces of a puzzle. These layers are assembled by assembling stage 114 to create a single credential image 116 that can be used at a later stage for printing.

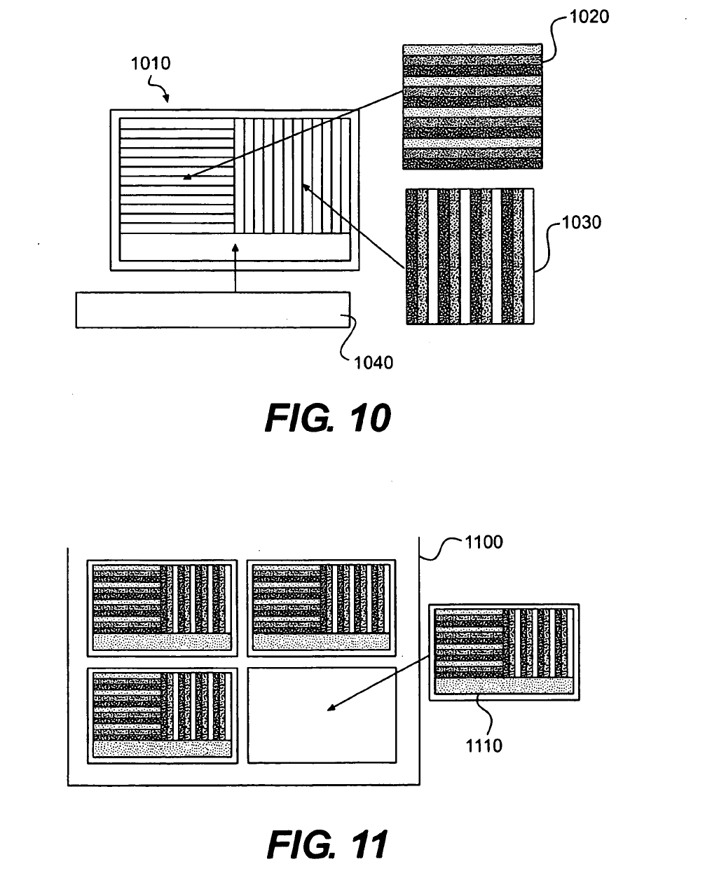

As noted, assembling stage 114 can also merge static (possibly non-encoded or pre-encoded) layers together with the encoded layers. A single layer may not need to be encoded and can be merged with the final credential image without any additional processing. This layer can be merged over or under the encoded layers, as a background or foreground. FIG. 10 illustrates an example of the assembly process, wherein encoded layers 1020, 1030 and static layer 1040 are merged together into a single credential image defined by template 1010.

Depending on the printer hardware it may be possible to fit more than one credential on a single sheet of polyoptic material, thereby allowing multiple credentials 116 to be printed at once. Tiling stage 118 creates a blank canvas, called a sheet, and then arranges one or more credentials 116 on sheet 120. Once sheet 120 is full, or there are no more credentials 116 to print, sheet 120 is sent to printing stage 122. FIG. 10 illustrates an example of the tiling process, where credential 1110 is added to sheet 1100.

Printing stage 122 is the final stage in creating a credential. Here, sheet 120, which contains a plurality of credentials, is printed to the polyoptic material. Printing stage 122 manages the printer hardware and delivers sheet 120 to the printer.

Depending on the printer hardware and configuration, this may be a direct request to the printer, the sheet file may be placed into some sort of “hot folder”, or some other mechanism may be used to print sheet 120. In one embodiment, printing stage 122 is hardware dependent to enable it to take full advantage of the hardware being used.

As sheet 120 includes a plurality of credentials, the image file produced by tiling stage 118 can be quite large. In one example, sheet 120 is embodied as a TIFF file that can be larger than 500 MB though the system may be configured to write out files with compressed formats specific to individual printers.

In one embodiment, a streaming TIFF encoder is used to accommodate the large TIFF file sizes. This streaming TIFF encoder is a means by which exceptionally large TIFF files (e.g., 500 MB or higher) can be created and managed in such a way that only a fraction of the image remains in memory at any one time.

To create such an image, certain predefined data is known up front. These data include, but are not necessarily limited to: the final image dimensions, the color depth (e.g., 3-byte RGB, 4-byte CMYK, etc.), and individual tile dimensions. To construct the image, smaller “tiles” are created that represent smaller, isolated areas of the full image. Upon creation, a blank TIFF file is written piece-meal, wherein a standard TIFF header is written, followed by a section of small (1 to 4 bytes, generally), repeating picture elements representing a white (or some other solid color) field. Then, as each individual tile of the output image is generated, it is written to a specific section of the file so that it will appear in the correct location of the final, composite image.

FIG. 11 illustrates an example of tiling multiple credentials on a sheet medium prior to being scored and/or cut from a sheet.

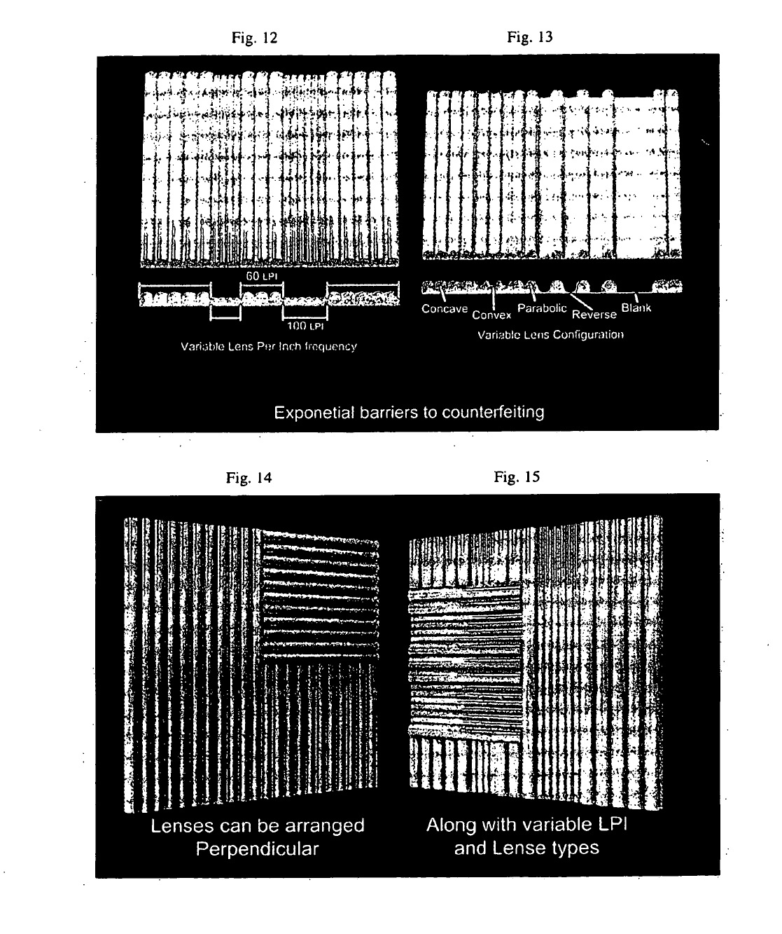

FIG. 12 shows a variable lens pitch or frequency, which may be formed in polyoptic regions. Pixel locations of printed images of a view set may be arranged (i.e., encoded) to accommodate the respective pitches of the lenses to produce a unique effect in each of the variable pitch regions. This way, encoding techniques may be expanded beyond a single-pitch arrangement.

FIG. 13 shows different shaped lenses in a variable lens configuration that may be incorporated in a polyoptic region of an encoded credential, which generated yet further unique visual effects in response to a changing view angle.

FIG. 14 shows an arrangement of horizontal and vertical rows of lens that may be incorporated in a polyoptic region. In this arrangement, separate and distinct visual effects are generated differently for vertical and horizontal sweeps in view angel.

FIG. 15 shows a variable pitch lens that may be incorporated into a lens arrangement similar to that shown in FIG. 14, but produces in further distinct visual effects.

As apparent, encoding of images according to numerous combinations of lens structures and arrangements may be incorporated on a credential to achieve security, unique and varied visual effects, anti-counterfeit or other measures. In addition, the lens layer may be formed to include non-polyoptic regions that produce no visual effect upon the underlying image. Instead of having lens formations, these regions may simply be planar or a complete absence of material in regions in which no visual effect is desired.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. For example, although the illustrated polyoptic material is characterized by rows of lenticular lenses, a matrix or other pattern of lens elements may also be provided to generate polyoptic effects. An encoded image that makes up a view set may be interlaced, interleaved, combined or mixed by other patterns. Phraseology and terminology employed herein are for the purposes of description and should not be regarded as limiting. A database or data store may be a digital data stored in a memory device or a physical list of information (manually or automatically generated) from which data is obtained or retrieved manually. A lens may comprise any light-bending, frequency-shifting, or focusing medium of any shape. A polyoptic effect includes a change in visual effect in response to a change in view angle, whether in color, picture, motion, animation, visual effect, or any other visual phenomenon. Retrieval may be accomplished manually or electronically by a computer device. A medium or sheet on which an image is printed may comprise any natural or synthetic material that carries a printing substance, e.g., ink. Thus, the invention defined by the appended claims is not limited by the specific illustrations described above. Different embodiments can be formed by different combinations of the features described herein. It is intended that polyoptic and non-polyoptic regions can be placed on one or both sides of the credential medium.

What is claimed is:

1. A method of producing a credential for printing on a credential medium that includes at least one polyoptic region including a plurality of lens elements to enable viewing of respective images of a view set according to view angle, said method comprising:
retrieving a view set that includes at least two images;
generating an encoding pattern that defines pixel characteristics of respective images of said view set;
assigning pixel locations of said respective images on said medium according to said encoding pattern and said lens elements thereby to form an encoded image; and
printing said encoded image on said medium according to assigned pixel locations thereby to enable viewing of respective images of said view set according to view angle.

2. The method of claim 1, wherein said medium includes a second polyoptic region and said method further comprises:
retrieving a second view set that includes at least two images;
generating a second encoding pattern that defines pixel characteristics of respective images of said second view set;
assigning pixel locations of respective images of said second view set on said medium according to said second encoding pattern and said lens elements thereby to form a second encoded image; and
printing said second encoded image on said medium according to assigned pixel locations to enable viewing of respective images of said second view set according to view angle.

3. The method of claim 1, wherein the pixel characteristics of said encoding pattern is defined by position, size, intensity, color, masking, interlacing, interleaving, scrambling, mixing, transformation, alteration, translation of said pixels, and a combination thereof.

4. A method of printing a credential on a credential medium that includes a polyoptic region defined by a plurality of lenses that enable viewing of respective images of a view set according to view angle, said method comprising:
obtaining an encoded image that embodies a view set that includes at least two images;
assigning respective locations of pixels of said encoded image on said medium according to a pattern of said plurality of lenses on said medium and a desired view angle of each image of said view set; and
printing said encoded image on said medium according to assigned pixel positions to enable viewing of respective images of said view set according to view angle.

5. The method of claim 4, wherein said encoded image comprises one of positioning, sizing, intensity, color, masking, interlacing, interleaving, scrambling, mixing, transformation, alteration, translation of said pixels, and a combination thereof of pixels of respective images of said view set.

6. The method of claim 5, wherein at least one of said images comprises an image determined according to at least one of biometric information and biographic text information.

7. A method of producing a credential image for printing on a credential medium having a polyoptic region defined by a plurality of lenses that enable viewing of respective images of a view set according to view angle, said method comprising:
encoding pixel characteristics of a plurality of images of said view set to form an encoded image;
assembling said encoded image with a non-encoded image into a credential image; and
printing said credential image on the medium wherein said encoded image is printed onto said polyoptic region of said medium and said non-encoded image is printed onto a non-polyoptic region of said medium.

8. The method of claim 7, wherein one of said plurality of images is a biometric image.

9. The method of claim 7, wherein said plurality of images is a biographic text image.

10. The method of claim 7, wherein said polyoptic region includes a plurality of lenses that produce one of an appear/disappear, color switch, color wash, image switch, movement, moving pattern, parallax, and size change effect in response to a change in view angle.

11. The method of claim 7, wherein said non-polyoptic region produces no effect.

12. The method of claim 7, further comprising:
encoding pixel characteristics of a second plurality of images in a second view set into a second encoded image; and
incorporating said encoded image and said second encoded image onto a dynamic area of said medium that changes from credential to credential.

13. The method of claim 12, further comprising incorporating said non-encoded image into a static layer of said medium that does not change from credential to credential.

14. The method of claim 13, further comprising assembling said dynamic area and said static area into said credential image for printing on said medium.

15. A method of producing a group of encoded credential images for printing on a credential medium having at least one polyoptic region, said method comprising:
retrieving a dynamic image layer that includes an encoded image formed of a plurality of images having encoded pixels wherein at least one of said plurality of images is unique to a first credential;
retrieving a static background layer that is not unique to said first credential;
assembling said dynamic image layer and said static background layer into a first credential image;
repeating said retrieving step to assemble a second credential image; and
printing said first credential image and a second credential image together onto a unitary medium wherein said dynamic layers are printed in respective polyoptic regions of said medium and said static background layers are printed in non-polyoptic regions.

16. The method of claim 15, wherein said dynamic layer includes a second encoded image formed from a second plurality of images.

17. The method of claim 15, wherein one of said plurality of images is one of a biometric image and a biographic text image.

18. The method of claim 15, wherein one of said encoded pixels comprises one of positioning, sizing, intensity, color, masking, interlacing, interleaving, scrambling, mixing, transformation, alteration, translation of said pixels, and a combination thereof thereby to provide an optical effect according to a change in view angle.

19. A system to generate an encoded credential image for printing on a credential medium, said system comprising:
an encoder that encodes a characteristic of pixels of a plurality of images of a view set to form an encoded image to permit viewing of respective images of said view set according to view angle, said encoded image having a printing size that is less than an area defined for a printed credential;
an assembler that combines said encoded image with a non-encoded image into a credential image, and
a printer to print said assembled image on said medium.

20. The system of claim 19, wherein one of said plurality of images is one of a biometric image and a biographic text image.

21. The system of claim 19, wherein said characteristic comprises at least one of positioning sizing, intensity, color, masking, interlacing, interleaving, scrambling, mixing, transformation, alteration, translation of said pixels, and a combination thereof.

22. A batch of credentials produced during a production run comprising:
a credential medium on which each credential is placed, said medium including a print medium and a polyoptic lens layer having a pattern of lens elements; and
at least two credentials of said batch including unique encoded images embodying pixels of at least two images having pixels encoded on said medium relative to said lens elements to enable, for each said credential, a separate viewing of a distinct image according to a view angle.

22. The credential of claim 22, wherein said pattern of lens elements comprises rows of generally convex lenses.

23. The credential of claim 23, wherein the pitch or frequency of said rows varies within a polyoptic region.

24. The credential of claim 21, wherein the lens elements and positions of pixels of said images produce visual effects that include at least one of appear/disappear, color change, color wash, image switch, movement, moving pattern, parallax, and size change effect in response to a change in view angle.

25. A batch of credentials printed on a credential medium that includes at least one polyoptic lens layer having a plurality of lenses to enable viewing of respective images of a view set according to a view angle, said batch of credentials being produced by:
retrieving a view set that includes at least two images;
providing an encoding scheme that defines a characteristic of pixels of respective images of said view set;
assigning said characteristic to pixels of said respective images thereby to form an encoded image; and
printing said encoded image on said medium according to said characteristic thereby to produce said batch of credentials each enabling viewing of respective images of said view set according to the view angle.

26. A group of credentials printed on a credential medium that includes at least one polyoptic lens layer having a plurality of lenses to enable viewing of respective images of a view set according to a view angle, said group of credentials being produced by:
obtaining an encoded image that embodies a view set of at least two images;
assigning respective locations of pixels of said encoded image on said medium according to a pattern of said plurality of lenses and a view angle of each image of said view set; and
for each said credential of said group, printing said encoded image on said medium according to assigned pixel positions.

27. The method of claim 26, wherein encoding of said encoded image comprises one of positioning, sizing, intensifying, coloring, masking, interlacing, interleaving, scrambling, mixing, transformation, altering, and translating pixels.

28. The method of claim 27, wherein at least one of said images comprises at least one of biometric information and a text image.

29. A set of credentials each being printed on a credential medium that includes at least one polyoptic lens layer having a plurality of lenses to enable viewing of respective images of a view set according to a view angle, said set of credentials being produced by:
for at least two credentials of said set, encoding pixels of a plurality of images of a view set to form an encoded image;
assembling said encoded image with a non-encoded image into a credential image; and
printing said credential image on the medium wherein said encoded image is printed onto a polyoptic area of said polyoptic lens layer and said non-encoded image is printed onto a non-polyoptic area of said medium.

30. A plurality of credentials each being printed on a credential medium that includes at least one polyoptic lens layer having a plurality of lenses to enable viewing of respective images of a view set according to a view angle, each said credentials being produced by:
retrieving a dynamic image layer that includes an encoded image formed of a plurality of images having an encoded pixel characteristic wherein at least one of said plurality of images is unique to a first credential;
retrieving a static background layer that is not unique to said first credential;
assembling said dynamic image layer and said static background layer into a first credential image; and
printing said first credential image and a second credential image together on a single medium wherein said dynamic layers are printed in respective polyoptic areas of said medium.
